(19) United States
(12) Patent Application Publication
(10) Pub. No.: US 2007/0255742 A1
(43) Pub. Date: Nov. 1, 2007

(54) Category Topics

(75) Inventors: Gregory A. Perez, Redmond, WA (US); Rodney C. Edwards, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/380,902

(22) Filed: Apr. 28, 2006

(51) Int. Cl. G06F 9/00

(52) U.S. Cl. 707/102; 715/751; 715/733; 715/968; 715/810

(57) ABSTRACT

A category topic includes a data incarnation and a sensory representation. The appearance of the sensory representation is adjusted upon changes to the content of the data incarnation. In a described implementation, a title of the category topic is used to create the sensory representation as displayed on a user interface (UI). In another described implementation, the data incarnation includes a source definition and a keyword definition that jointly specify information that is to be included in the content. In yet another described implementation, at least part of a category topic may be shared with a destination user.

### BACKGROUND

The internet contains a wealth of information. In fact, the types of information are so varied and the amount of information is so vast that it is difficult to find information without using some kind of search tool. Search tools are typically powered by search engines. In response to a search input, a given search engine usually returns a listing of search results that depends solely upon the mechanism employed by the given search engine to crawl the internet and to index the information that is encountered during the crawling. The search results listings returned by search engines tend to be overwhelmingly massive and relatively unorganized.

### SUMMARY

A category topic includes a data incarnation and a sensory representation. The appearance of the sensory representation is adjusted upon changes to the content of the data incarnation. In a described implementation, a title of the category topic is used to create the sensory representation as displayed on a user interface (UI). In another described implementation, the data incarnation includes a source definition and a keyword definition that jointly specify information that is to be included in the content. In yet another described implementation, at least part of a category topic may be shared with a destination user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other method, system, scheme, apparatus, device, media, procedure, API, arrangement, etc. implementations are described herein.

### BRIEF DESCRIPTION OF THE DRAWINGS

The same numbers are used throughout the drawings to reference like and/or corresponding aspects, features, and components.

FIG. 1 is an example environment in which category topics may be initiated, used, shared, and so forth.

FIG. 2 illustrates an example of a data incarnation (DI) and a sensory representation (SR) of a category topic.

FIG. 3 is a program window that illustrates visual examples of sensory representations for different category topics.

FIG. 4 is a flow diagram that illustrates an example of a method for initiating and using a category topic.

FIG. 5 is a program window that illustrates an example sharing of a category topic for an originating device.

FIG. 6 is a program window that illustrates the example sharing of a category topic from FIG. 5 for a destination device.

FIG. 7 is a flow diagram that illustrates an example of a method for sharing a category topic.

FIG. 8 is a block diagram of an example device that may be employed in conjunction with category topics.

### DETAILED DESCRIPTION

### Introduction

As described above, search results are usually returned by search engines in a listing format. The search results may be listed in accordance with some ranking algorithm, such as the presumed relevance. However, the search results are generally nonspecific, and they are relatively incapable of being managed and/or organized.

In contrast, certain described implementations for category topics enable search results to be managed and organized. Search results can also be rendered far more specific depending on a given user's preferences. More generally, category topics enable information to be collected and utilized. Category topics also enable collected information to be, for example, shared and discussed.

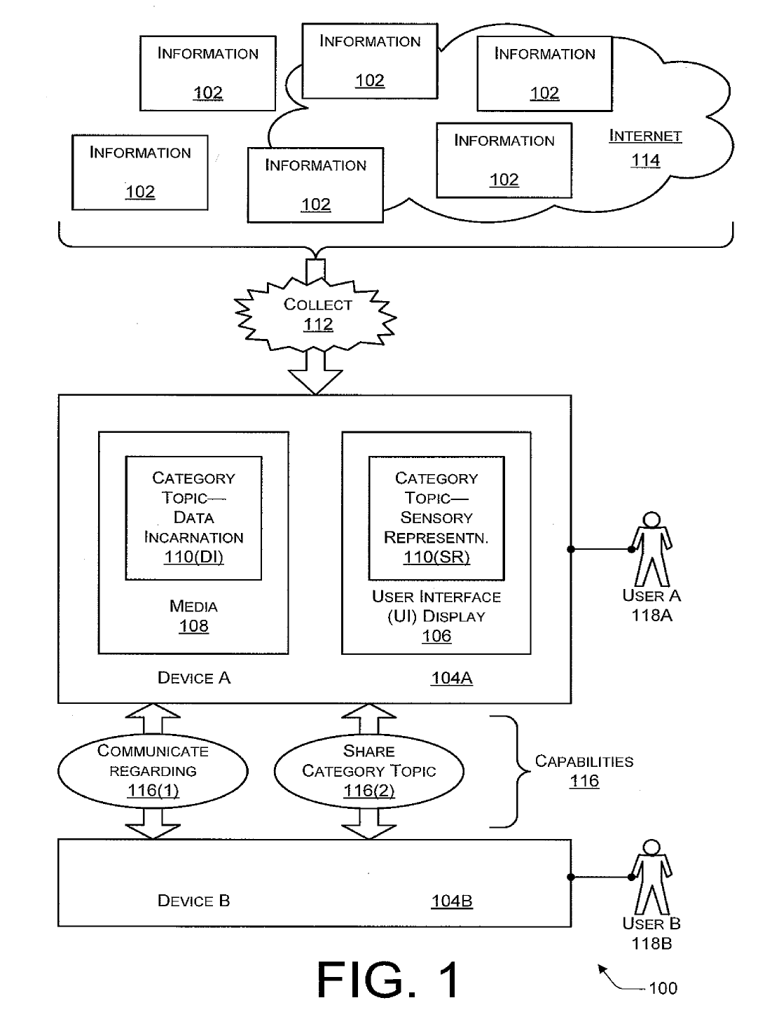

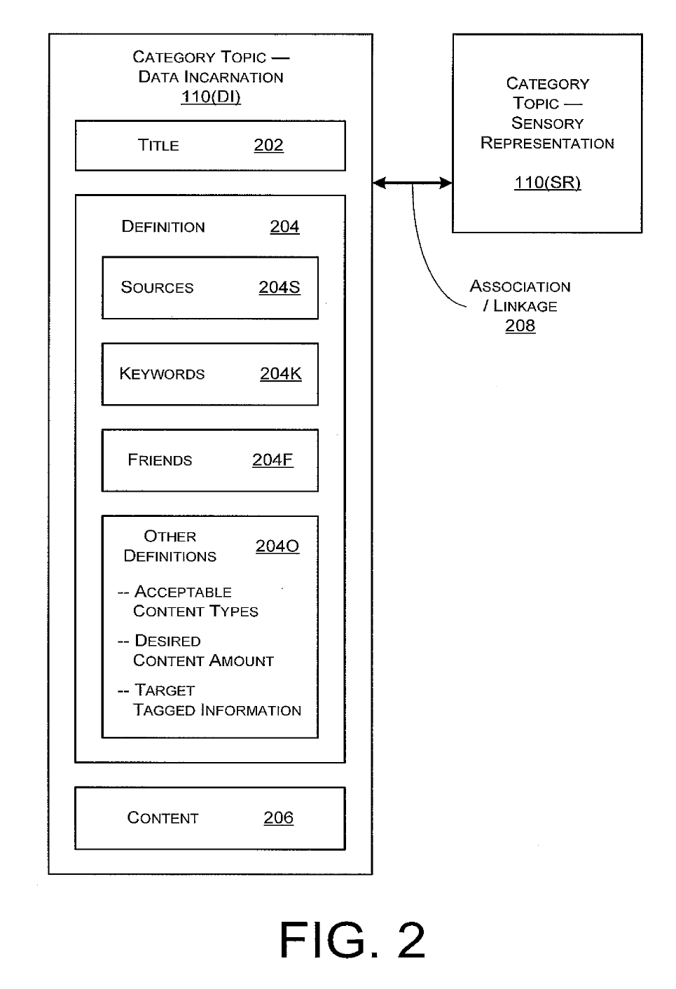

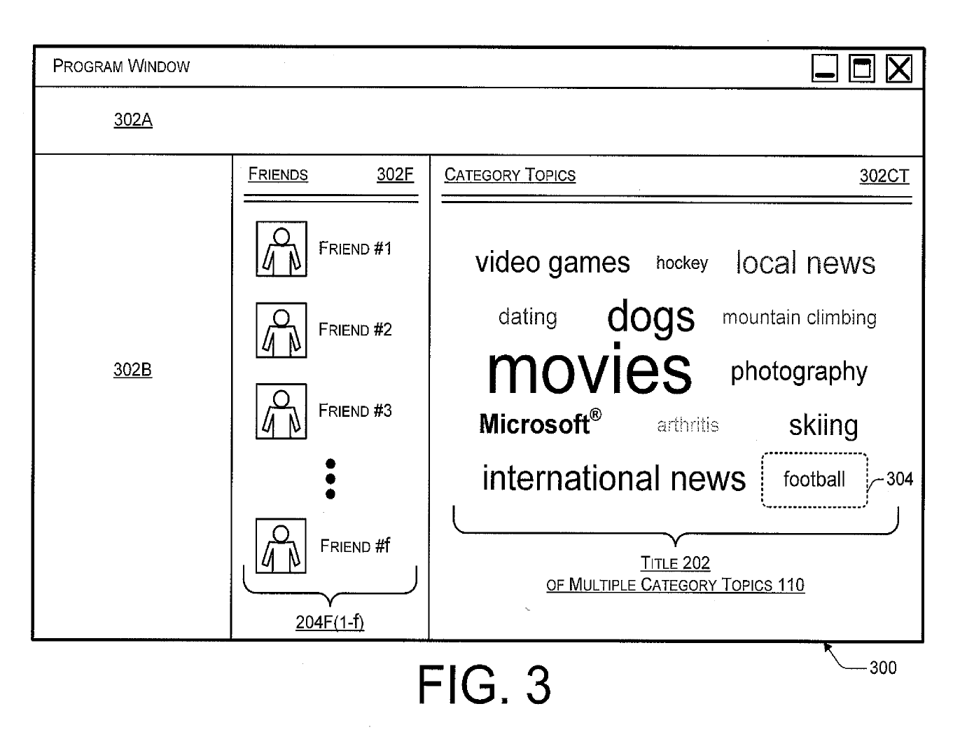

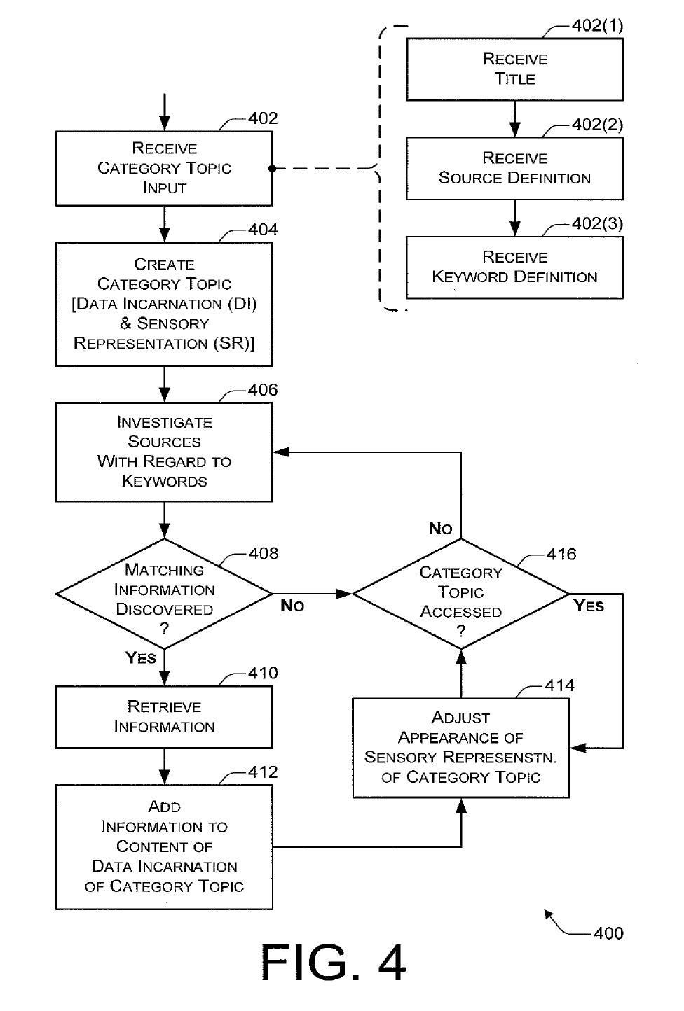

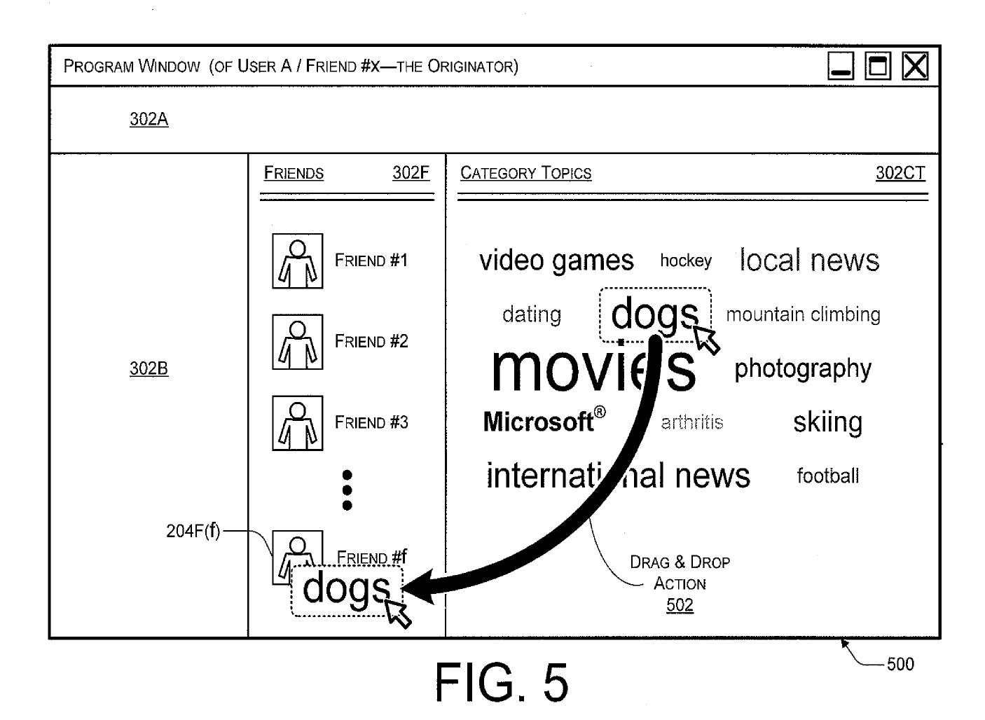

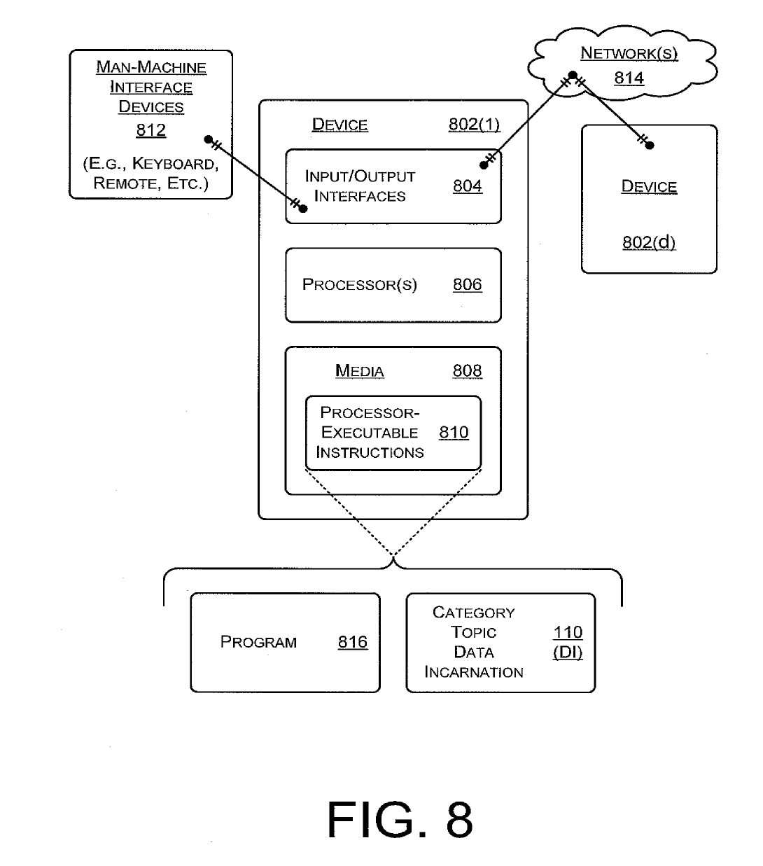

The remainder of the “Detailed Description” is divided into four sections. A first section is entitled “Example Environments for Category Topics” and references FIGS. 1 and 2. A second section is entitled “Example Implementations for Initiating and Using Category Topics” and references FIGS. 3 and 4. A third section is entitled “Example Implementations for Sharing Category Topics” and references FIGS. 5-7. A fourth section is entitled “Example Device Implementations for Category Topics” and references FIG. 8.

### Example Environments for Category Topics

FIG. 1 is an example environment 100 in which category topics 110 may be initiated, used, shared, and so forth. As illustrated, environment 100 includes information 102 and devices 104 with corresponding users 118. More specifically, environment 100 includes a device A 104A that corresponds to a user A 118A and a device B 104B that corresponds to a user B 118B. Some of information 102 is shown as being located on the internet 114.

In a described implementation, device A 104A includes a user interface (UI) display 106 and media 108. Category topic 110 is separated into two portions: a category topic data incarnation (DI) portion 110(DI) and a category topic sensory representation (SR) portion 110(SR). Category topic-data incarnation 110(DI) is stored at media 108. Category topic-sensory representation 110(SR) is displayed at UI display 106. In operation, device A 104A collects 112 at least some of information 102 in accordance with category topic 110.

Information 102 represents the various types of information to which a user may wish to have access. Information 102 may be located on an internet 114, such as on a web page of the world wide web (WWW) portion of internet 114. Information 102 may also be located at other places, including by way of example but not limitation, a local memory device, an intranet, some general network, a remote memory device, some combination thereof, and so forth. Information 102 may exist in any format, including by way of example but not limitation, text, image, graphics, audio, video, a web page, a news article, a spreadsheet file, a public-format document, a multimedia clip, some combination thereof and so forth.

Information 102 is collected 112 by searching various sources of information 102 and then retrieving information 102 that comports with at least one criterion established for a given category topic 110. The components of a category topic 110 are described below in this section with particular reference to FIG. 2. The initiation and use of a category topic 110 are described below in the following section with particular reference to FIGS. 3 and 4.

The data structures of category topics as described herein, as well as programs that implement and/or manipulate them, enable a number of capabilities 116 with regard to information 102 that has been collected 112 in accordance with a given category topic 110. For example, implementation of category topics enables user A 11 SA to share 116(2) a given category topic 110 with user B 118B. As another example, implementation of category topics enables user A 118A to communicate 116(1) with user B 118B regarding the given category topic 110. These communication and sharing capabilities 116(1) and 116(2) are described further herein below with particular reference to FIGS. 5-7.

FIG. 2 illustrates an example of a data incarnation of a category topic 110(DI) and a sensory representation of a category topic 110(SR). As illustrated, data incarnation portion 110(DI) includes three “major” parts: a title 202, a definition 204, and content 206. Definition part 204 includes four “minor” parts: sources 204S, keywords 204K, friends 204F, and other definitions 2040.

In a described implementation, title 202 is a user-supplied title that serves to represent content 206 that is to be collected for the given category topic 110. For example, a user may supply a title that describes the collected content 206. Definition 204 includes at least one criterion for the information 102 (of FIG. 1) that is to be collected for content 206.

Content 206 includes the collected information 102. Content 206 may include varying amounts of each collected item of information 102. Example content amounts for each item of collected information 102 are: a uniform resource locator (URL) or other link, a title, a summary or abstract, a thumbnail, an initial portion, portion(s) around target keywords, a sample of an audio/visual file, the entirety of the information 102, some combination thereof, and so forth.

Sources 204S includes one or more sources as designated by a user that are to be searched to retrieve content 206 for the given category topic 110. Example sources include a local storage unit, a network location (e.g., on an intranet or the internet), and so forth. Network locations may be specified, for example, as a URL, including an entire web site or any number of pages thereof.

Keywords 204K are target keywords as stipulated by a user that are to be searched for at the sources defined in sources 2048. The target keywords may be stipulated by the user in a simple Boolean format (e.g., all specified words are present in each qualifying item of information 102), in a complex Boolean format (e.g., with logical operators, distance limitations, etc.), in a natural language format, and so forth.

In operation, initiation of a category topic 110 effectively subscribes a user to retrieve or pull content 206 that matches the specifications of definition 204. Hence, an item of information 102 that is part of a source as designated in sources 204S and that comports with the keywords as stipulated in keywords 204K qualifies as matching information 102. The matching information 102 is retrieved and added to content 206 as new content. The user may experience (read, view, listen to, watch, etc.) information 102 from content 206 whenever category topic 110 is accessed.

Friends 204F is a listing of friends as identified by a user that are to be associated with the given category topic 110. A user may easily communicate with the identified friends whenever the user is accessing content 206. For example, when a user is accessing an item of information 102 from content 206, the user can send an instant message (IM), an email, a text message, etc. to any or all of the friends associated with the given category topic 110 as identified in friends 204F. As is described further herein below, the identified friends can also be used to define a community of users for a category topic 110 and/or a group of category topics 110.

Other definitions 2040 may include any other information that specifies what information 102 is to be collected, how it is to be collected, and/or how it can be utilized. Examples of other definitions 2040 include, but are not limited to, acceptable content types, desired content amount, and whether tagged information is targeted. A user may specify which content types (e.g., text only, text and audio, all types, etc.) are to be collected. A user may specify the amount (e.g., a link, a thumbnail, a summary, the entirety, etc.) of each item of information 102 that is to be retrieved and/or stored at content 206. A user may also specify whether tagged information is to be retrieved when the tag matches the specified definitions. Although not shown in FIG. 2, data incarnation portion 110(DI) may also include permissions information.

Tags are metadata that are manually or automatically applied to a given item of information 102. For example, an article about the Seattle Seahawks may be tagged with “NFL” (regardless of whether the term “NFL” actually appears in the article). In a described implementation, each item of information 102 that is stored as content 206 may be tagged with the corresponding title 202.

As illustrated, there is an association or linkage 208 between data incarnation portion 110(DI) and sensory representation portion 110(SR) of a given category topic 110. In a described implementation, sensory representation portion 110(SR) comprises the visual and/or aural component of category topic 110. From time to time, it may manifest any of the parts of data incarnation portion 110(DI). For example, it may display the friends identified in friends 204F and/or the title provided in title 202.

Additionally, sensory representation portion 110(SR) is capable of communicating status information about category topic 110 to a user. It is also capable of communicating changes to the status information. Example implementations for sensory representation portion 110(SR) are described in the following section with particular reference to FIGS. 3 and 4.

### Example Implementations for Initiating and Using Category Topics

FIG. 3 is a program window 300 that illustrates visual examples of sensory representations for different category topics. Program window 300 is a window of a program (e.g., program 816 of FIG. 8) that implements at least part of category topics as described herein. Examples for the program include, but are note limited to, a browser program, a program that interacts with a web service, a general communications program, a general user interface or shell program, an operating system (OS) program, a productivity program, some combination thereof, and so forth. An example web service and/or program is the Windows® Live® service/product from Microsoft Corp. of Redmond, Wash. Another example is a feature of a toolbar from an internet search company (e.g., Yahoo! ®, Google, etc.).

As illustrated, program window 300 includes multiple sections 302. These sections 302 are: section 302A, section 302B, friends section 302F, and category topics section 302CT. Sections 302A and 302B represent a variety of possible visual aspects that may be included as part of the UI of program window 300. For example, section 302A may include menu options, tabs, a current network location, a currently-active feature, and/or a currently-active alias for a current user, and so forth. Section 302B may include, for example, a hierarchy of available and/or favorite locations that may be accessed by the currently-active alias. However, sections 302A and 302B, if present, may be positioned, sized, and/or formulated differently.

In a described implementation, friends section 302F includes the friends 204F(1) . . . 204F(f) that are associated with one or more category topics 110. Each friend of friends 204F may be displayed as an image (e.g., an avatar, a photograph, etc.), as identifying text (e.g., a name, an alias, etc.), some combination thereof, and so forth. As shown, each friend includes an image and identifying text.

The displayed friends may be the friends that are associated with all category topics 110 of a cluster of category topics for the current user, with a defined subset of category topics 110, with a single currently-selected category topic 110, and so forth. Selection of a single category topic 110 may be effected by rollover with a pointer icon (e.g., an arrow, a hand, etc.), by moving a selection indicator 304 (with a graphical pointing device and a pointer icon, with keyboard commands, a combination thereof, etc.), and so forth.

A selected category topic 110 may be so indicated with a selection indicator 304, which may be realized as a selection ring as shown in program window 300. Although selection indicator 304 is shown as a ring formed from a dashed line, selection can be indicated in alternative manners. Example alternative implementations for selection indicator 304 include, but are not limited to, visual brightening, color changing, inverse video, changing a background color or hue, having a button look depressed, having a tab be moved to the top, adding a check mark or other indicator, some combination thereof, and so forth.

In a described implementation, category topics section 302CT includes multiple category topics 110. As illustrated, each respective displayed category topic 110 is represented textually by its respective title 202. The example titles 202 include “video games”, “hockey”, “local news”, “dating”, “dogs”, “mountain climbing”, “movies”, “photography”, “Microsoff®” “arthritis”, “skiing”, “international news”, and “football”. Although each sensory representation portion 110(SR) is implemented textually as title 202, it may alternatively include other text, a still or moving graphic, a combination thereof, and so forth.

Although general subject areas are usually used as category topic titles 202 in this written description, more specific titles 202 and subject areas may instead be initiated by a user for a given category topic 110. For example, instead of “video games”, a user may initiate a category topic for a specifically named video game (e.g., “Halo®”). Also, instead of “football”, a user may initiate a category topic for a specific named professional football team (e.g., “Seattle Seahawks”).

By way of example only, titles 202 are displayed at different font sizes and in different tints. The varying font size indicates the amount of overall information in the content 206 of a corresponding category topic 110. The font size may be scaled along with the amount of overall information. In other words, the larger the font size, the greater the amount of overall information. Thus, there is more overall information in the “movies” category topic than in the “hockey” category topic.

The varying tint or brightness indicates the newness or recentness of the information in the content 206 of the corresponding category topic 110. The tint appearance may be scaled along with the recentness of the information as it ages and/or with the newness as it is experienced by a user. For example, the tint of the title is faded or made less vibrant as the information for the corresponding category topic 110 ages. In other words, the lighter the text, the less recent is the information within content 206. Thus, the information within the “Microsoft®” category topic is more recent than the information within the “mountain climbing” category topic.

The category topic scaling or scalable indexing as shown in FIG. 3 and the text above that describes it are examples only. Category topic scalable indexing may be implemented in any of many possible alternatives, some of which are described below.

Scalable indexing is a scheme for visually and/or aurally cueing a user to change(s) within designated category topics using size, color, sound, and/or motion, and so forth. Scalable indexing harnesses the generation of topic-specific keywords, or tags, to categorize collections of related information. Scalable indexing notifies a user to a change in a category topic's status over time. Scalable indexing may employ elements of size, color, sound and/or motion in a multi-faceted, customizable manner that alerts the user in a sensory way when change(s) occurs in their designated category topics.

Regardless of the content type, a user or system can group similar or related items of information under a singular title or label and, e.g., visually display changes to the collected information in terms of content volume changes, accessing/usage changes, recentness, and so forth. By delivering a scalable scheme for indexing collected information in a visual way, users can be better informed at a mere glance as to what content may be most useful or interesting to them at any given moment.

In a described implementation, scalable indexing for category topics involves implementing one or more scalable indexing pairs. Each scalable indexing pair includes a content change and an associated scaling parameter. Example scalable indexing pairs include, but are not limited to: Size scaling (e.g., font point size or thickness of text that) reflects changes to the volume of the corresponding content of a given category topic. Color scaling (e.g., color tint that) reflects changes to the time relevance of the corresponding content. Motion scaling (e.g., movement of graphics or letters, flashing of text, etc.), including the speed of visual movement, reflects an item of information's usage or speed of content change. Audio scaling (e.g., audio volume) can determine the “importance” of an item of information upon notification of its retrieval by the subscription aspect of category topics. Actual implementations may map content changes with associated scaling parameters differently.

Additional example features that may be implemented by a particular UI include, but are not limited to: Sorting—a user is empowered to sort items of information under one label or tag using pivots on content volume (e.g., most amount of content additions versus least amount of content additions), recentness (e.g., newer content addition versus older content addition), usage (e.g., most-recently accessed versus least-recently accessed), speed (e.g., rapid additions versus slower additions), and importance (e.g., most important versus least important). Customization—users are empowered to map the functions of the scalable indexing pairs listed above as desired. In other words, users may map a particular content change to be associated with a given scaling parameter as desired. For example, a user may cause motion scaling to alert them to volume content changes (e.g., instead of the size scaling described above).

Category topics section 302CT, as shown in FIG. 3, illustrates an individual category topic (or content) cluster for a single user or system. It is shown in a textual view, but the user can instruct the program to switch to a graphical view or a combination textual and graphical view. The individual content cluster may be a personal content cluster when it is an aggregated view of a single user's categorized content, or it may be a system content cluster when it is an aggregated view of categorized content that is algorithmically determined by a system. A community content cluster is an aggregated view of categorized content algorithmically and/or behaviorally determined by a number of users.

With a cluster sharing feature, the program provides an ability to add, remove, or combine clusters of information within a social network. The social network may be defined, for example, by friends 204F. With a topic publishing feature, the program provides a capability for a system or a user to publish (e.g., to a web page) categorized clusters of content for public consumption. With a categorized topic view feature, the program provides a capability for a user or a system to organize content under a singular designation (e.g., text, photo, color, or sound).

FIG. 4 is a flow diagram 400 that illustrates an example of a method for initiating and using a category topic. Flow diagram 400 includes eight (8) “primary” blocks 402-416 and three (3) “secondary” blocks 402(1)-402(3). Although the actions of flow diagram 400 may be performed in other environments and with a variety of hardware and software combinations, a program (e.g., program 816 of FIG. 8) presenting a program window 300 (of FIG. 3) and manipulating a category topic 110 (of FIGS. 1 and 2) may be used to implement the method of flow diagram 400.

At block 402, a category topic input is received. For example, inputs defining a category topic 110 may be received from a user A 118A. Specific example inputs are shown in blocks 402(1), 402(2), and 402(3). At block 402(1), a title is received. At block 402(2), a source definition is received. At block 402(3), a keyword definition is received. Thus, a title 202, sources 204S, and keywords 204K may be received from user A 118A. Other specifications for category topic 110 may also be received.

At block 404, a category topic having a data incarnation and a sensory representation is created. For example, data incarnation portion 110(DI) of category topic 110 may be formulated and stored at media 108 of device A 104A, and sensory representation portion 110(SR) may be displayed at UI display 106. Data incarnation portion 110(DI) may be created first, with the creation of sensory representation portion 110(SR) following immediately thereafter or sometime later.

After category topic 110 has been specified at block 402 and created at block 404, category topic 110 has been initiated by user A 118A. Category topic 110 may then be used.

At block 406, one or more sources are investigated with regard to target keywords. For example, each source specified in sources 204S may be searched to determine if the target keywords specified in keywords 204K are present. It is therefore determined at block 408 if information matching the specifications for the category topic has been discovered. If not, then the method of flow diagram 400 continues at block 416, which is described below.

If, on the other hand, it is determined (at block 408) that matching information is discovered responsive to the investigation (of block 406), then at block 410, the discovered matching information is retrieved. For example, the desired amount of information as specified in other definitions 2040 may be retrieved. At block 412, the retrieved information is added to the content of the data incarnation of the topic category. For example, the retrieved matching information 102 may be added to content 206 of data incarnation portion 110(DI) of category topic 110.

At block 414, the appearance of the sensory representation of the topic category is adjusted. For example, the visual or aural appearance of sensory representation portion 110(SR) of category topic 110 may be adjusted based on individual, cluster, and/or global scalable indexing parameters that are currently in effect and applicable. For instance, the font size of text that is the displayed title 202 in a category topic section 302CT may be increased responsive to the addition of content 206. Alternatively, an aural cue may be given and/or motion scaling may be employed.

At block 416, it is detected if the topic category has been accessed by the user. If not, then at block 406 the designated sources may be investigated again with regard to the stipulated keywords to determine if new matching content has been added to the designated sources. If, on the other hand, the category topic has been accessed (as detected at block 416), then at block 414 the appearance of the sensory representation of the category topic may be adjusted to reflect that there is currently no new content present (if the accessing entailed experiencing all existing content 206).

### Example Implementations for Sharing Category Topics

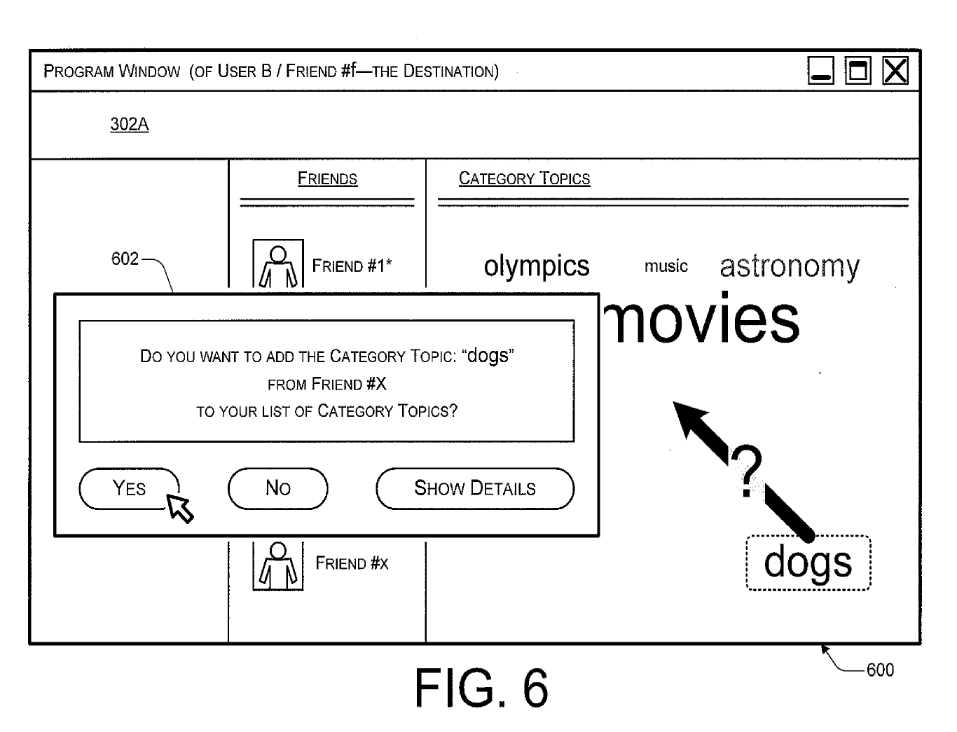

Jointly, FIGS. 5 and 6 illustrate the sharing of a category topic from a UI perspective. FIG. 5 is a program window 500 of a program executing on device A 104A for user A 118A (of FIG. 1). FIG. 6 is a program window 600 of a program executing on device B 104B for user B 118B. User A is offering to share the “dogs” category topic with user B. Hence, program window 500 is for the originator of the category topic sharing, and program window 600 is for the destination or recipient of the category topic to be shared.

FIG. 5 is a program window 500 that illustrates an example sharing of a category topic from the perspective of an originating device 104A. Program window 500 is for a user A who originates a sharing of a category topic 110. The category topic “dogs” is to be shared with the identified friend #f, who is user B. From the perspective of user B, user A is identified as friend #x (which is illustrated in FIG. 6).

As illustrated, user A commands that the “dogs” category topic be shared with user B (e.g., instructs the program to share the “dogs” category topic) by selecting and dragging the word “dog”. The word “dog” is the sensory representation portion 100(SR) of category topic 110. It is dragged from category topics section 302CT and dropped at the “Friend #f” 204F(f) entry of friends definition 204F that are displayed in friends section 302F. This dragging and dropping action 502 is depicted by the large arrow.

The program providing program window 500, individually or in conjunction with one or more other programs, enables user A to command that the “dogs” category topic be shared with Friend #f 204F(f) in any of a number of mechanisms in addition to the dragging and dropping action 502. For example, a right-click with a pointer user-interface device may precipitate a pop-up menu that includes an option to “Share with . . . ”. Second, the category topic may be copied and then pasted into an email. Third, the program may include a “Share with . . . ” menu option and/or toolbar button (e.g., as part of section 302A). Other command approaches may alternatively be implemented.

FIG. 6 is a program window 600 that illustrates the example sharing of a category topic from the perspective of a destination device 104B for the intended recipient user B 118B (of FIG. 1). User B corresponds to the Friend #f 204F(f) of user A as illustrated in FIG. 5. The program that provides program window 600 receives the “dogs” category topic as offered from the originating device 104A corresponding to user A, which is “Friend #x” to user B.

After receiving the offer for the “dogs” category topic, the program presents a dialogue box 602. Dialogue box 602 asks user B, “Do you want to add the Category Topic: “dogs” from Friend fx to your list of Category Topics?” Dialogue box 602 includes three options: “yes”, “no”, and “show details”. The “show details” option enables user B to review the specification of the “dogs” category topic. For example, for the “dogs” category topic, sources 204S, keywords 204K, and/or content 206, etc. may be displayed to user B. After reviewing the specification for the “dogs” category topic, user B may then elect whether or not to accept the offered category topic.

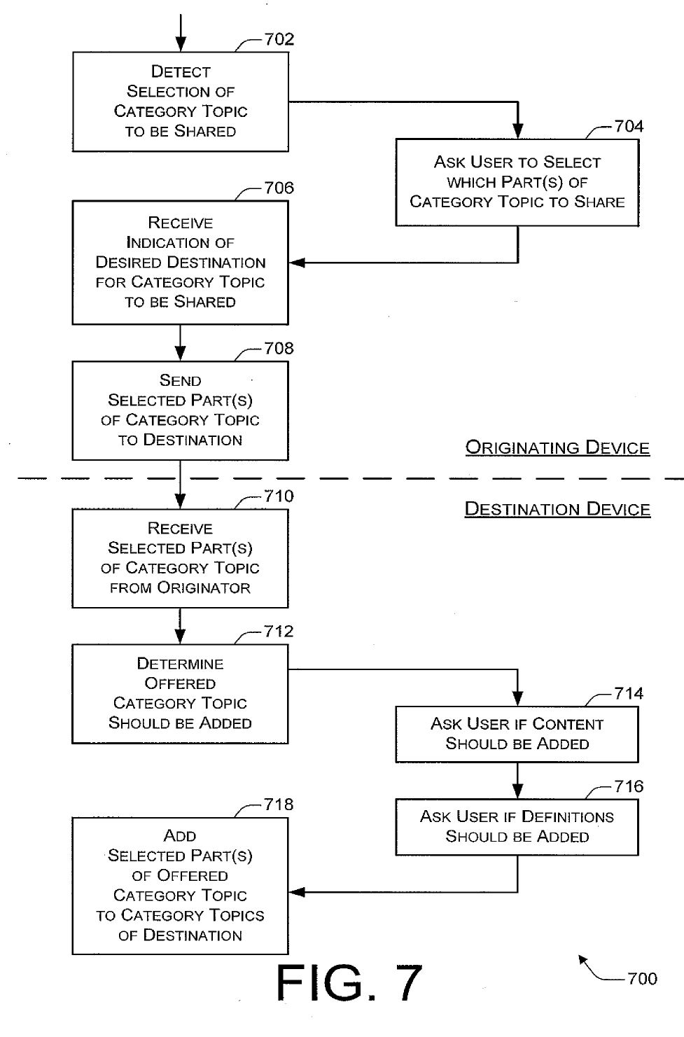

FIG. 7 is a flow diagram 700 that illustrates an example of a method for sharing a category topic. Flow diagram 700 includes nine (9) blocks 702-718. Although the actions of flow diagram 700 may be performed in other environments and with a variety of hardware and software combinations, two programs presenting program windows 500 and 600 (of FIGS. 5 and 6, respectively) may be used to implement the method of flow diagram 700. The actions of blocks 702-708 may be performed by an originating program executing on an originating device 104A, and the actions of blocks 710-718 may be performed by a destination program executing on a destination device 104B.

At block 702, selection of a category topic that is to be shared is detected. For example, a program may detect that an originating user 118A has selected a category topic 110 for sharing with a pointer device or keyboard input by selecting a sensory representation portion 110(SR) in a category topic section 302CT of a UI program window 500.

At block 704, an originating user is asked to select which part(s) of the selected category topic are to be shared. For example, the program may ask user 118A if both the definitions 204 and the content 206 of the selected category topic 110 are to be shared. In an example scenario, an originating user may wish to share the information 102 collected in content 206 while not burdening the destination user with definitions 204 that are not likely to be utilized to subscribe to new content. In a contrary scenario, an originating user may wish to enable a destination user to start collecting new information 102 for content 206 without sending stale information 102, so the originating user sends definitions 204 but not existing content 206. This selection of parts may also be accomplished using a program or user-established default setting (i.e., without directly asking the user as in block 704).

At block 706, an indication of the desired destination for the category topic to be shared is received. For example, the program may receive destination input from user 118A that indicates a particular friend that might appreciate the selected category topic 110. As shown in FIG. 5, the actions of blocks 702 and 706 may be effected using, for instance, a single dragging and dropping action 502.

At block 708, the selected part(s) of the category topic to be shared are sent to the indicated destination. For example, originating device 104A may send one or more parts of category topic 110 across a network such as internet 114 to destination device 104B. When content 206 is being sent, different content types, ages, etc. may be selectively transmitted. When definition part 204 is being sent, friends 204F (or any other part of category topic 110) may be omitted from the transmission for privacy, security, or personal reasons.

At block 710, the selected part(s) of the category topic are received from the originator at the destination. For example, destination device 104B may receive the transmitted parts of category topic 110 from originating device 104A.

At block 712, it is determined that the offered category topic should be added. For example, a program executing on destination device 104B may determine that category topic 110 as offered from the originating user 118A should be added to a category topics cluster of the destination user 118B. This determination may be made based on program or user-established default settings, on a response from a direct inquiry to the destination user (e.g., as shown in FIG. 6), and so forth.

The amount of the offered category topic 110 that should be added may be based on a program or user-established default setting, on answers to the questions of blocks 714 and 716, and so forth. At block 714, the destination user is asked if the content of the offered category topic should be added. At block 716, the destination user is asked if the definitions of the offered category topic should be added. The destination user's answers to the questions of blocks 714 and 716 enable a receiving destination user to tailor which part(s) of a received category topic 110 are to be added to the category topics cluster of the destination user.

At block 718, the selected part(s) of the offered category topic are added to the category topics of the destination device. For example, definitions 204 and/or content 206 (in addition to title 202) of the received category topic 110 may be added to the category topics cluster of destination user 118B. The data incarnation portion 110(DI) may be stored in media, and the sensory representation portion 110(SR) may be displayed in a category topic section 302CT of a program window 600.

After a received category topic 110 has been added to a destination user's category topics cluster, the destination user is empowered to amend any of the specifications of the data incarnation portion 110(DI). In other words, a destination user may amend the title 202, definitions 204, or content 206 of the received category topic 110.

In addition to the category topic sharing described above, users may also communicate regarding 116(1) (of FIG. 1) a given category topic. For example, IMs, emails, real-time or saved voice messages, and other communications may be sent to any one or more friends listed in friends 204F. A communication may be sent from a sending user to a recipient user, with the communication referencing a particular category topic. The particular category topic may be, for example, a category topic that is currently selected by the sending user. In other words, the program may enable communications by a users with respect to a particular category topic when the particular category topic is selected, to the friends identified in friends 204F.

### Example Device Implementations for Category Topics

FIG. 8 is a block diagram of an example device 802 that may be employed in conjunction with category topics. For example, a device 802 may realize, execute, or otherwise implement a UI as described herein above. In certain implementations, devices 802, such as devices 104 (of FIG. 1), are capable of communicating across one or more networks 814, such as internet 114.

As illustrated, two devices 802(1) and 802(d) are capable of engaging in communication exchanges via network 814. Example relevant communication exchanges include those between an originating device 104A and a destination device 104B that relate to sharing and/or communicating regarding category topics. Other example relevant communication exchanges include those initiated by device 104A to acquire information 102 for content 206.

More generally, device 802 may represent a server or a client device; a storage device; a workstation or other general computer device; a set-top box or other television device; a personal digital assistant (PDA), mobile telephone, or other mobile appliance; some combination thereof; and so forth. As illustrated, device 802 includes one or more input/output (I/O) interfaces 804, at least one processor 806, and one or more media 808, which may correspond to media 108 (of FIG. 1). Media 808 includes processor-executable instructions 810. Although not specifically illustrated, device 802 may also include other components.

In a described implementation of device 802, I/O interfaces 804 may include (i) a network interface for communicating across network(s) 814, (ii) a display device interface for displaying information such as a UI on a display screen, (iii) one or more man-machine device interfaces, and so forth. Examples of (i) network interfaces include a network card, a modem, one or more ports, and so forth. Examples of (ii) display device interfaces include a graphics driver, a graphics card, a hardware or software driver for a screen/television or printer, etc. to create a UI. Examples of (iii) man-machine device interfaces include those that communicate by wire or wirelessly to man-machine interface devices 812 (e.g., a keyboard or keypad, a mouse or other graphical pointing device, a remote control, etc.) to manipulate and interact with a UI.

Generally, processor 806 is capable of executing, performing, and/or otherwise effectuating processor-executable instructions, such as processor-executable instructions 810. Media 808 is comprised of one or more processor-accessible media. In other words, media 808 may include processor-executable instructions 810 that are executable by processor 806 to effectuate the performance of functions by device 802.

Thus, realizations for category topics may be described in the general context of processor-executable instructions. Generally, processor-executable instructions include routines, programs, applications, coding, modules, protocols, objects, interfaces, components, metadata and definitions thereof data structures, application programming interfaces (APIs), etc. that perform and/or enable particular tasks and/or implement particular abstract data types. Processor-executable instructions may be located in separate storage media, executed by different processors, and/or propagated over or extant on various transmission media.

Processor(s) 806 may be implemented using any applicable processing-capable technology. Media 808 may be any available media that is included as part of and/or accessible by device 802. It includes volatile and non-volatile media, removable and non-removable media, and storage and transmission media (e.g., wireless or wired communication channels). For example, media 808 may include an array of disks for longer-term mass storage of processor-executable instructions, random access memory (RAM) for shorter-term storage of instructions that are currently being executed, flash memory for medium to longer term and/or portable storage, optical disks for portable storage, and/or link(s) on network 814 for transmitting code or other communications, and so forth.

As specifically illustrated, media 808 comprises at least processor-executable instructions 810. Generally, processor-executable instructions 810, when executed by processor 806, enable device 802 to perform the various functions described herein. Processor-executable instructions 810 may include, for example, a category topic data incarnation 110(DI) and/or a program 816 that is capable of implementing the UIs and functions described herein. Examples include, but are not limited to, those UIs and functions shown in FIGS. 1 and 2-7.

The devices, actions, aspects, features, functions, procedures, modules, data structures, schemes, approaches, UIs, architectures, components, etc. of FIGS. 1-8 are illustrated in diagrams that are divided into multiple blocks. However, the order, interconnections, interrelationships, layout, etc. in which FIGS. 1-8 are described and/or shown are not intended to be construed as a limitation, and any number of the blocks can be modified, combined, rearranged, augmented, omitted, etc. in any manner to implement one or more systems, methods, devices, procedures, media, apparatuses, APIs, arrangements, etc. for category topics.

Although systems, media, devices, methods, procedures, apparatuses, techniques, schemes, approaches, arrangements, and other implementations have been described in language specific to structural, logical, algorithmic, and functional features and/or diagrams, it is to be understood that the invention defined in the appended claims is not necessarily limited to the specific features or acts described above. Rather, the specific features and acts described above are disclosed as example forms of implementing the claims.

What is claimed is:

1. A device comprising:
one or more processor-accessible media including a data incarnation of a category topic, the data incarnation comprising a title and content, the content including information; and
a user interface including a category topic section, the category topic section comprising a sensory representation of the category topic, the sensory representation comprising the title;
wherein an appearance of the title for the sensory representation is adjusted when the information of the content is changed.

2. The device as recited in claim 1, wherein the data incarnation further comprises one or more definitions that specify what information qualifies for the content.

3. The device as recited in claim 2, wherein the one or more definitions include at least one designated source and at least one stipulated keyword.

4. The device is recited in claim 1, wherein:
the data incarnation further comprises at least one identified friend; and
the user interface further includes a friends section that displays the at least one identified friend.

5. The device is recited in claim 1, wherein an adjustment to the appearance of the title for the sensory representation comprises an adjustment to a size, a color, a tint, a sound, or a motion associated with the title.

6. The device as recited in claim 1, wherein the appearance of the title for the sensory representation is further adjusted when the content is accessed or as time transpires.

7. The device as recited in claim 1, wherein the user interface provides a mechanism for a user to share the category topic.

8. One or more processor-accessible media comprising processor-executable instructions that, when executed, cause a device to perform actions comprising:
receiving a title input for a category topic from a user;
receiving a source definition input for the category topic from the user;
receiving a keyword definition input for the category topic from the user;
creating a data incarnation for the category topic that includes the title, the source definition, and the keyword definition; and
creating a sensory representation for the category topic that communicates a status of the category topic to the user;
wherein the data incarnation is associated with the sensory representation such that changes to the data incarnation may be reflected by the sensory representation.

9. The one or more processor-accessible media as recited in claim 8, wherein the processor-executable instructions, when executed, cause the device to perform further actions comprising:
investigating one or more sources from the source definition with regard to at least one keyword from the keyword definition; and
if information matching the source definition and the keyword definition is discovered during the investigating, retrieving the matching information and adding the matching information to content of the data incarnation for the category topic.

10. The one or more processor-accessible media as recited in claim 9, wherein the processor-executable instructions, when executed, cause the device to perform a further action comprising:
responsive to the adding, adjusting the sensory representation for the category topic so as to reflect the addition of the matching information to the content of the data incarnation.

11. The one or more processor-accessible media as recited in claim 8, wherein the processor-executable instructions, when executed, cause the device to perform further actions comprising:
detecting if content of the category topic has been accessed by the user; and
if so, adjusting the sensory representation for the category topic so as to reflect a change in newness of the content of the category topic.

12. The one or more processor-accessible media as recited in claim 8, wherein the processor-executable instructions, when executed, cause the device to perform further actions comprising:
receiving a command from the user to share the category topic with a friend who is a user of a remote device; and
sending at least part of the category topic to the remote device.

13. The one or more processor-accessible media as recited in claim 8, wherein the processor-executable instructions, when executed, cause the device to perform further actions comprising:
receiving an instruction from the user that establishes a scalable indexing pair, the scalable indexing pair including a content change and an associated scaling parameter; and
responsive to detecting the content change in the category topic, adjusting the sensory representation for the category topic so as to reflect the detected content change in accordance with the associated scaling parameter.

14. The one or more processor-accessible media as recited in claim 8, wherein the processor-executable instructions, when executed, cause the device to perform further actions comprising:
receiving a friend definition input for the category topic from the user; and
enabling communications by the user, with respect to the category topic when the category topic is selected, to at least one friend identified in the friend definition.

15. A method comprising:
detecting selection by a user of a category topic to be shared, the category topic including a data incarnation portion and a sensory representation portion, wherein an appearance of the sensory representation portion reflects changes to content of the data incarnation portion;
receiving an indication from the user of a desired destination for the category topic to be shared; and
sending at least one part of the category topic to the indicated destination.

16. The method as recited in claim 15, wherein the detecting and the receiving comprise a dragging and dropping action by the user in which the sensory representation portion is (i) dragged from a category topic section of a user interface to a representation of a friend, which corresponds to the indicated destination, located in a friend section of the user interface and (ii) dropped at the representation of the friend.

17. The method as recited in claim 15, further comprising:
asking the user to select if a definitions part and/or a content part of the category topic is to be shared;
wherein the sending comprises sending at least one of the definitions part or the content part to the indicated destination based on the user selection.

18. The method as recited in claim 15, further comprising:
receiving the at least one part of the category topic;
determining if the received category topic should be added to a category topic cluster of a destination user; and
if so, adding the received category topic to the category topic cluster of the destination user.

19. The method as recited in claim 18, further comprising:
asking the destination user if a definitions part of the received category topic should be added; and
asking the destination user if a content part of the received category topic should be added;
wherein the determining is performed based on answers to the asking, and wherein the adding is performed responsive to the answers to the asking.

20. The method as recited in claim 18, further comprising:
sending from the user to the destination user a communication that references the category topic.
